(19) United States
(12) Patent Application Publication
(10) Pub. No.: US 2006/0284848 A1
(43) Pub. Date: Dec. 21, 2006

(54) System and method for saving power

(75) Inventor: Chao-Chiang Lin, Taipei (TW)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/455,181

(22) Filed: Jun. 19, 2006

(30) Foreign Application Priority Data
Jun. 21, 2005 (TW) 094120694

(51) Int. Cl. G09G 5/00

(52) U.S. Cl. 345/169

(57) ABSTRACT

The present invention provides a system for saving power of a portable electronic apparatus, which comprises a central processing unit, a display unit connecting to the central processing unit, an audio processing unit connecting to the central processing unit, and a sensor unit receiving an external signal representing reduced illumination in the environment near the portable electronic apparatus and transmitting a control signal to the audio processing unit, and in response the audio processing unit causes the central processing unit and the display unit to enter into a power-saving mode.

### FIELD OF THE INVENTION

The present invention relates to system improvement and method for saving power, and more particularly to a portable electronic apparatus having a sensor for sensing external conditions (such as changes of light or static electricity) while being in a communication mode, and generating a control signal to activate the portable electronic apparatus to enter into a power-saving mode.

### BACKGROUND OF THE INVENTION

Technology has known a rapid, spectacular development in recent several decades. A variety of advanced electronic products are widely used by people, resulting in a significant improvement of living quality. The trend of developing electronic products is slimness, compactness, and lightness. For example, pocket-sized, special-purpose personal computers (e.g., PDAs) are developed as replacement of thick notebooks. Currently, a PDA is capable of not only storing much information but also providing a number of functions including alarm, Walkman, mobile phone, sending and receiving e-mails, and Internet access. However, for such multi-functional electronic product its standby time is limited by the short operating time provided by its battery power supply.

Referring to FIG. 1, a well known portable electronic apparatus is shown in its perspective. The portable electronic apparatus is a typical PDA. Referring to FIG. 2, the portable electronic apparatus 11 comprises an audio processing unit 13, a speaker unit 14, a CPU (Central Processing Unit) 15, and a display unit 16. The portable electronic apparatus 11 not only serves as a personal secretary but also is capable of receiving the external audio via the audio processing unit 13. The external audio is either an audio signal or a data signal. The audio processing unit 13 is adapted to process the audio or data signal prior to transmitting the same to the CPU 15. The CPU 15 then further processes the processed audio or data signal in order to either show messages on the display unit 16 or transmit sound waves to the speaker unit 14 for sound amplification.

Typically, the power supply of the portable electronic apparatus is a battery for maintaining normal operation of the portable electronic apparatus. The portable electronic apparatus is implemented as a PDA. For such a multi-functional PDA, the only way to solve the problem of limited operating time due to short battery life is to find an optimum power saving means. For addressing the above problem, a sensor unit for sensing is incorporated into a PDA as contemplated by the invention. The sensor unit is adapted to sense a using mode (e.g., operation mode or communication mode) of the PDA. In a case of the portable electronic apparatus entered into a communication mode, an external signal (e.g., light or static electricity) received by the sensor unit causes the PDA to enter into a sleeping mode with the display screen being closed. By configuring a method as above, it is also possible to save the power of PDA.

### SUMMARY OF THE INVENTION

It is an object of the present invention to provide a system and a method for saving power of a portable electronic apparatus so as to overcome the above drawback of the prior art.

In one aspect of the present invention, a system is provided in a portable electronic apparatus for saving power, the system comprising a central processing unit; a display unit connecting to the central processing unit; an audio processing unit connecting to the central processing unit; and a sensor unit adapted to function as an ambient sensor for sensing an external condition, such as changes of light or static electricity, while the portable electronic apparatus being in a communication mode where the portable electronic apparatus is in communication with another portable electronic apparatus.

In another aspect of the present invention, the sensor unit is adapted to generate a control signal in response to the external condition being sensed.

In yet another aspect of the present invention, the changes of light or static electricity of the external condition being sensed is taken as an external signal which is in turn employed to cause the central processing unit to enter into a power-saving mode such as a standby mode or a sleeping mode.

In a further aspect of the present invention, in a case of the portable electronic apparatus being in a communication mode, a user of the portable electronic apparatus may put the portable electronic apparatus near the ear to receive a call. Thereby the sensor unit receives an external signal representing reduced illumination in the environment near the portable electronic apparatus and generates a control signal and then transmits the control signal to the central processing unit for causing the central processing unit and the display unit to enter into a power saving mode.

In yet further aspect of the present invention, a method for saving power is provided for greatly saving power by configuring most components of the portable electronic apparatus into the power-saving mode.

The above and other objects, features and advantages of the present invention will become apparent from the following detailed description taken with the accompanying drawings.

### BRIEF DESCRIPTION OF THE DRAWINGS

FIG. 1 is a perspective view of a conventional portable electronic apparatus (e.g., PDA);

FIG. 2 is a block diagram of the portable electronic apparatus of FIG. 1;

FIG. 3 is a block diagram of a preferred embodiment of portable electronic apparatus according to the invention;

FIG. 4 is a detailed block diagram of the portable electronic apparatus of FIG. 3; and

FIG. 5 is a flowchart depicting a process for saving power in a communication mode of the portable electronic apparatus according to the invention.

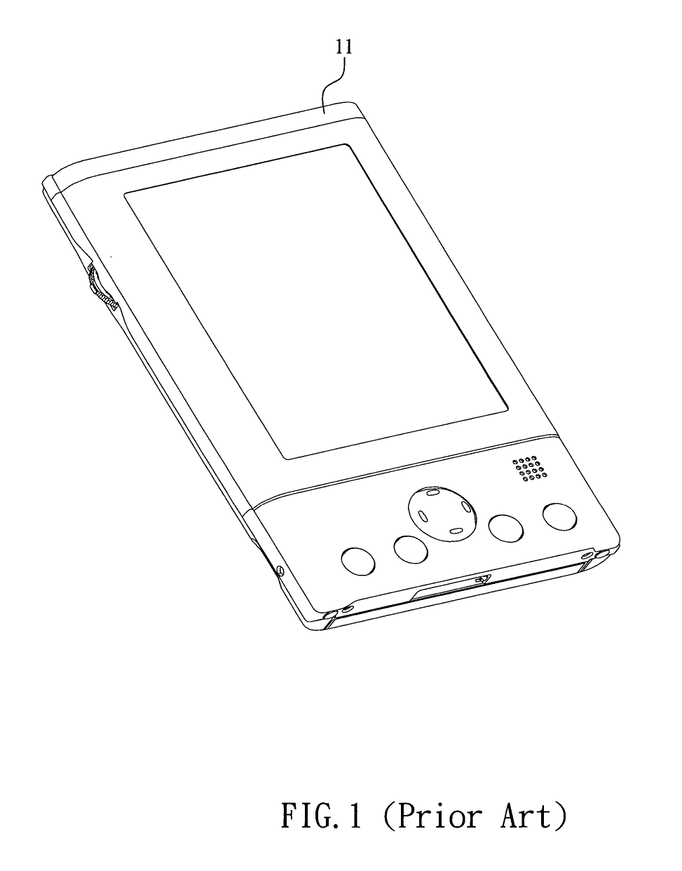

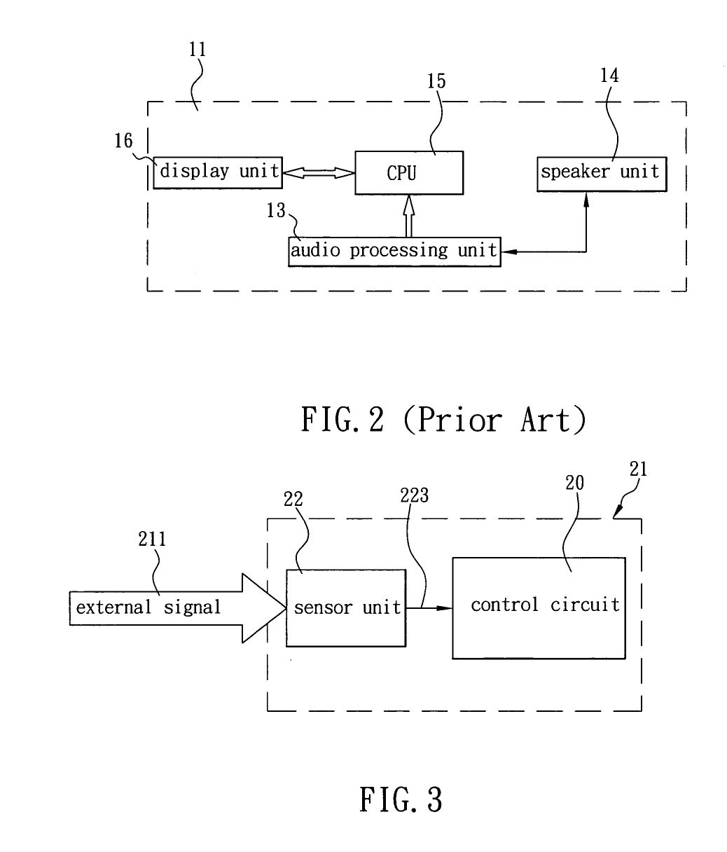

### DETAILED DESCRIPTION OF THE PREFERRED EMBODIMENTS

Referring to FIG. 3, a portable electronic apparatus 21 in accordance with a preferred embodiment of the invention is shown. The portable electronic apparatus 21 comprises a control circuit 20 and a sensor unit 22. Each component is discussed in detailed below.

The portable electronic apparatus 21 is implemented as a PDA. The PDA not only serves as a pocket-sized, special-purpose personal computer but also has a communication capability. The control circuit 20 comprises an audio processing unit 13 for receiving an external audio signal, a speaker unit 14, a CPU 15 and a display unit 16, wherein the display unit 16 and an audio processing unit 13 respectively connect to the CPU 15 and the speaker unit 14 and the sensor unit 22 connect to the audio processing unit 13 respectively. The sensor unit 22 is employed as an ambient sensor by being incorporated into the portable electronic apparatus. The ambient sensor (i.e., the sensor unit 22) has the functionality of sensing external conditions of the portable electronic apparatus 21 by receiving an external signal 211. The external signal 211 in turn is employed to cause the central processing unit 11 and the display unit 16 to enter into a power-saving mode.

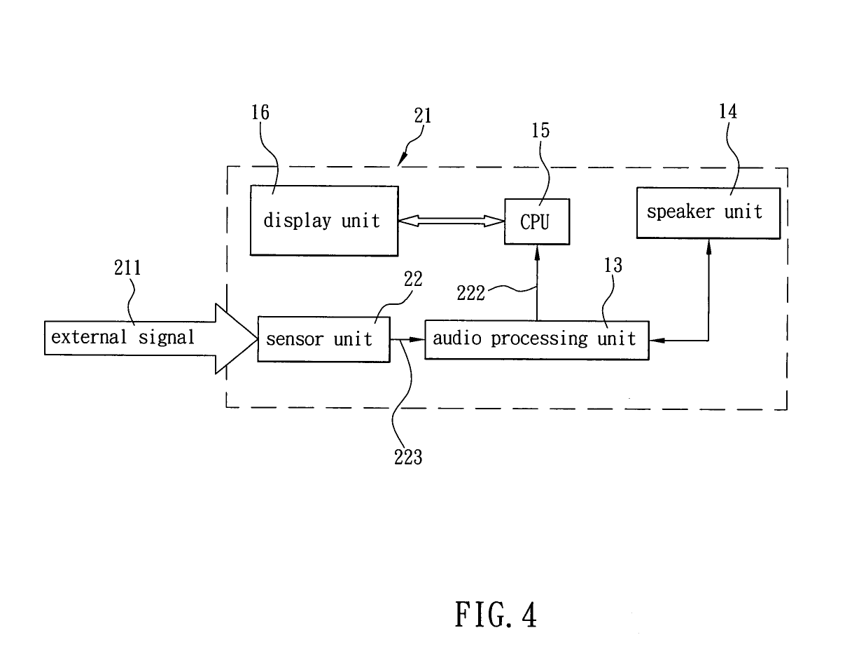

Referring to FIG. 4, a detailed block diagram of the portable electronic apparatus 21 is shown, wherein the display unit 16, speaker unit 14 and audio processing unit 13 respectively connect to the CPU 15, the sensor unit 22 and speaker unit 14 connect to the audio processing unit 13 respectively. In a case of the portable electronic apparatus 21 is in a communication mode where the portable electronic apparatus is in communication with another portable electronic apparatus, a user of the portable electronic apparatus 21 may put the portable electronic apparatus 21 near the ear to receive a call. Thus, a reduced illumination is sensed by the sensor unit 22. The reduced illumination represents a positive value of the external signal 211. Thereafter, the sensor unit 22 generates a control signal 223 and then transmits the control signal 223 to the audio processing unit 13. Next, the audio processing unit 13 converts the control signal 223 into an interrupt signal 222 which is then transmitted to the CPU 15. The interrupt signal 222 is adapted to control both the CPU 15 and the display unit 16 to enter into a standby mode or a sleeping mode. Other units of the portable electronic apparatus 21 still work normally. Advantageously, by causing both the CPU 15 and the display unit 16 to enter into the standby mode or the sleeping mode, it is possible to save the power of the portable electronic apparatus.

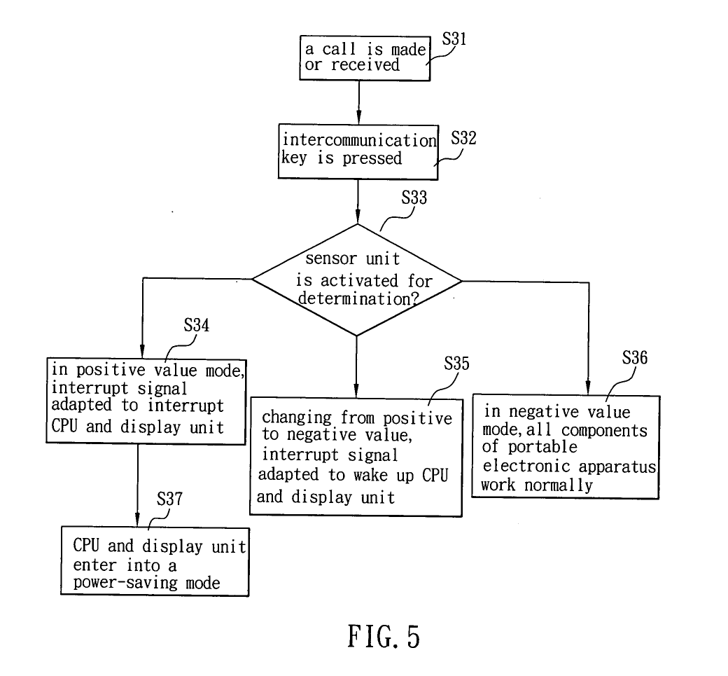

Referring to FIG. 5 in conjunction with FIGS. 3 and 4, it is flowchart depicting a process for saving power in a communication mode of the portable electronic apparatus 21 according to the invention, which comprises the steps of:

In step S31, a call is made or received while the portable electronic apparatus being in a communication mode;

In step S32, intercommunication key is pressed such that a user may use the communication functionality of the portable electronic apparatus 21 to communicate with another portable electronic apparatus.

In step S33, the sensor unit is activated to sense the external signal 211 of the portable electronic apparatus 21 and determine whether the external signal 211 is in a positive value, a negative value, or changing from a positive value to a negative value. If it is in a positive value, which means that a reduced illumination is sensed by the sensor unit 22, the portable electronic apparatus 21 goes to step S34. If it is in a negative value, which means that increased illumination is sensed by the sensor unit 22, the portable electronic apparatus 21 jumps to step S36. If it is changing from a positive value to a negative value, the portable electronic apparatus 21 jumps to step S35.

In step S34, the positive value of the external signal 211 is sensed by the sensor unit 22 when a user of the portable electronic apparatus 21 puts the portable electronic apparatus 21 near the ear of user to receive a call. Thus, an external signal 211 is sensed by the sensor unit 22 as representing the reduced illumination. A first control signal 223 is generated by the sensor unit 22 and transmitted to the audio processing unit 13. The audio processing unit 13 then converts the control signal 223 into an interrupt signal 222 which is then transmitted to the CPU 15 to cause both the CPU 15 and the display unit 16 to enter into a power-saving mode. The portable electronic apparatus 21 then jumps to step S37.

In step S35, the external signal 211 sensed by the sensor unit 22 is changing from a positive value to a negative value. In this changing mode, the portable electronic apparatus 21 is removed away from the ear of user, which means that the external signal 211 representing increased illumination is sensed by the sensor unit 22. In this step, a second control signal 223 is generated by the sensor unit 22 and transmitted to the audio processing unit 13. The audio processing unit 13 then converts the control signal 223 into an interrupt signal 222 which is then transmitted to the CPU 15 to cause both the CPU 15 and the display unit 16 to enter into a normal operating mode.

In step S36, the external signal 211 sensed by the sensor unit 22 is in the negative value, which means that the user of the portable electronic apparatus operates other functions thereof in a normal condition away from the ear thereof. A third control signal 223 is generated by the sensor unit 22 and transmitted to the audio processing unit 13. The audio processing unit 13 then converts the control signal 223 into an interrupt signal 222 which is then transmitted to the CPU 15 to cause both the CPU 15 and the display unit 16 to enter into a normal operating mode.

In step S37, both the CPU 15 and the display unit 16 enter into a sleeping mode or standby mode, resulting in power saving of the portable electronic apparatus 21.

While the invention herein disclosed has been described by means of specific embodiments, numerous modifications and variations could be made thereto by those skilled in the art without departing from the scope and spirit of the invention set forth in the claims.

What is claimed is:

1. A system in a portable electronic apparatus for saving power comprising:
a central processing unit;
a display unit connecting to the central processing unit;
an audio processing unit connecting to the central processing unit; and
a sensor unit receiving an external signal representing reduced illumination in the environment near the portable electronic apparatus, and transmitting a control signal to the audio processing unit, and in response the audio processing unit causes the central processing unit and the display unit to enter into a power-saving mode, wherein the reduced illumination results from that the portable electronic apparatus is close to a user of the portable electronic apparatus and in a communication mode where the portable electronic apparatus is in communication with another portable electronic apparatus.

2. The system of claim 1, wherein the sensor unit is an ambient sensor.

3. The system of claim 1, wherein the external signal is a light signal.

4. The system of claim 1, wherein the external signal is a static electrical signal.

5. The system of claim 1, wherein the power-saving mode is a standby mode.

6. The system of claim 1, wherein the power-saving mode is a sleeping mode.

7. The system of claim 1, wherein the portable electronic apparatus is a PDA (Personal Digital Assistant).

8. A method in a portable electronic apparatus which includes a central processing unit, an audio processing unit, a display unit and a sensor unit for saving power, said method comprising the steps of:
determining whether the portable electronic apparatus is in a communication mode where the portable electronic apparatus is in communication with another portable electronic apparatus;
if the portable electronic apparatus is in the communication mode, the sensor unit receiving an external signal representing reduced illumination in the environment near the portable electronic apparatus and transmitting a control signal to the audio processing unit, wherein the reduced illumination results from that the portable electronic apparatus is close to a user of the portable electronic apparatus and in the communication mode; and then
the audio processing unit causing the central processing unit and the display unit to enter into a power-saving mode.

9. The method of claim 8, further comprising the step of keeping the portable electronic apparatus operate normally if the portable electronic apparatus is not in a communication mode.

10. The method of claim 8, wherein the portable electronic apparatus enters a power-saving mode if the central processing unit and the display unit are in the power-saving mode.

11. The method of claim 8, wherein the portable electronic apparatus works normally if the central processing unit and the display unit work normally.

12. The method of claim 8, further comprising the step of determining a value of the external signal to be a positive or a negative value.

13. The method of claim 12, wherein the portable electronic apparatus enters the power-saving mode if a positive value of the external signal is determined.

14. The method of claim 12, wherein the portable electronic apparatus works normally if a negative value of the external signal is determined.

15. The method of claim 8, wherein the external signal is a light signal.

16. The method of claim 8, wherein the power-saving mode comprises a standby mode.

17. The method of claim 8, wherein the power-saving mode comprises a sleeping mode.

18. The method of claim 8, wherein the portable electronic apparatus is a PDA (Personal Digital Assistant).
